(19) United States
(12) Patent Application Publication
(10) Pub. No.: US 2005/0068465 A1
(43) Pub. Date: Mar. 31, 2005

(54) Adjustment of motion vectors in digital image processing systems

(76) Inventor: Roy Van Dijk, Eindhoven (NL)

Correspondence Address: US Philips Corporation;Intellectual Property Department, PO Box 3001, Briarcliff Manor, NY, 10510, US

(21) Appl. No.: 10/498,767

(22) PCT Filed: Dec. 5, 2002
(86) PCT No.: PCT/IB02/05165

(30) Foreign Application Priority Data
Dec. 20, 2001 (EP) 012050480

(51) Int. Cl. H04N 5/14

(52) U.S. Cl. 348/699

(57) ABSTRACT

An image processing device e.g., to drive a plasma display panel to perform both a subfield driven method and a motion compensation technique, in which motion vectors are estimated and their speed is reduced by a positive reduction factor R less than one.

### FIELD OF THE INVENTION

The present invention relates to an image processing device arranged to perform a motion compensation technique on received input signals, comprising an adapter for adapting the input signals to create images, a motion compensator for compensating the images for motion, a motion estimator for estimating motion vectors using the input signals, the motion vectors being used by the motion compensator.

### PRIOR ART

To increase the number of grey levels in Plasma Display Panels (PDP's), the so-called “subfield driven method” may be used. An image frame is shown in a number of successive periods called subfields. During a subfield, an amount of light is emitted which is dependent on the weight of the subfield. Each subfield has a different weight. A desired intensity level for a pixel in the image is realized by controlling the specific subfields. The human eye sees the sum of the intensity levels of the enabled subfields within a field (i.e. an image) due to the integrating character of the human eye. In this way a subfield driven method using for example 8 subfields can display a maximum of 2⁸ halftone levels. A well-known problem of PDPs using the subfield method is the occurrence of motion artefacts like false contouring and blur. To decrease motion artefacts, PDP systems may use motion compensation, as, e.g., described in copending Philips application having application number EP 01202410.5 [internal Philips reference number PHNL 010407], not published before the filing date of the present application.

Apart from motion compensation, in PDPs motion estimation may be used, e.g., in situations where received 50 Hz images are to be converted into 100 Hz images. Then, between any two received consecutive images one additional image need be calculated. To that end, the images are divided into blocks of a predetermined number of pixels, e.g., 8×8 pixels. For every block, a motion estimator determines a speed and direction of movement, with which the block is moving on a screen displaying the images, resulting in motion vectors. The additional images are then calculated using the motion vectors per block as determined and displayed between two received images.

However, when combining the “subfield driven method” with the motion estimation for PDPs, motion estimation vectors for all subfields per frame need to be calculated. If a frame comprises, e.g., 8 subfields instead of one, seven more motion vectors per frame need to be calculated.

Assuming that the human eye moves with a moving object on the screen, motion compensation may result in one or more subfields of a frame being displayed on different pixels as determined by the estimated motion vectors per subfield. Then, the human eye will receive all image data related to the same frame and correctly integrate all subfields to see the proper grey level related to the frame concerned.

Thus before displaying an image, the (luminances of) subfields are moved in space and time, using the motion vectors, to make the human eye experience the correct luminance at the correct pixel on the screen. In this way motion artefacts are reduced considerably.

However, motion vector estimation is not fee from errors. For instance, a block of 8×8 pixels may be part of a moving large object having one color. Then, adjacent to this block there are several “equal” blocks and it may be very difficult for the motion estimator to estimate the motion of the block concerned since it may be difficult to identify the block between its adjacent blocks that look the same and may have the same motion vectors. Then, it may happen that a motion estimator estimates a block to have a certain speed whereas the speed is in reality much lower. Applying a motion compensation in such a case may result in a decrease of the image quality. The reverse may also be true, i.e., an estimated speed is much lower than the real speed. Then, motion compensation also results in a decrease of image quality, however, less than in the first situation. Errors in the motion estimation may result in (unexpected) decrease of image quality.

In addition, at situations when the human eye is not tracking a moving object correctly, the calculated motion vectors differ from the motion of the eye. This also results in lower perceived quality.

It is an object of the present invention to provide an arrangement and a method for driving a display screen using motion compensation whereby motion artefacts are reduced when either the estimated motion vectors are incorrect or the human eye is not tracking the motion of an object on the screen.

### SUMMARY OF THE INVENTION

To obtain the object, the invention as defined at the outset is characterized in that the image processing device further comprises an adjustor for adjusting the motion vectors before feeding them to the motion compensator, the adjustor being arranged to multiply the motion vectors by a reduction factor, the reduction factor being a positive value less than one.

In such a device the chance of having a too high decrease in image quality due to a wrong motion estimation is significantly reduced while still having most advantages of motion compensation known from the prior art.

It is observed that U.S. Pat. No. 5,175,618 discloses a compression method for moving picture signals, where motion vectors are estimated and reduced before using them. This reduction relates to the conversion between motion vectors for a frame to motion vectors for a field.

Furthermore, the invention relates to a display arrangement, comprising an image processing device as defined above, and a display for receiving output signals from the motion compensator. The invention also relates to a method for driving an image processing device comprising:
receiving input signals;
adapting the input signals to produce consecutive images;
adjusting the consecutive images using motion compensation;
estimating motion vectors out of the input signals;
using the motion vectors in the motion compensation,
   characterized by adjusting the motion vectors before using them in the motion compensation by multiplying the motion vectors by a reduction factor, the reduction factor being a positive value less than one.

The invention also relates to a computer program product to be loaded by a digital image processing device, the computer program product providing the device with the capacity of:
receiving input signals;
adapting the input signals to produce consecutive images;
adjusting the consecutive images using motion compensation;
estimating motion vectors out of the input signals;
using the adjusted motion vectors in the motion compensation,
   characterized by adjusting the motion vectors before using them in the motion compensation by multiplying the motion vectors by a reduction factor, the reduction factor being a positive value less than one.

Finally, the invention relates to a data carrier provided with such a computer program product.

### BRIEF DESCRIPTION OF THE DRAWINGS

Below, the invention will be explained with reference to some drawings, which are intended for illustration purposes only and not to limit the scope of protection as defined in the accompanying claims.

FIG. 1 shows a schematic block diagram of an image-processing device according to the invention.

FIG. 2 is a figure of a “Subjective Mean Square Error” (SMSE) as a function of estimated motion vector speed with a tracking speed of a human eye as a parameter.

### DESCRIPTION OF PREFERRED EMBODIMENTS

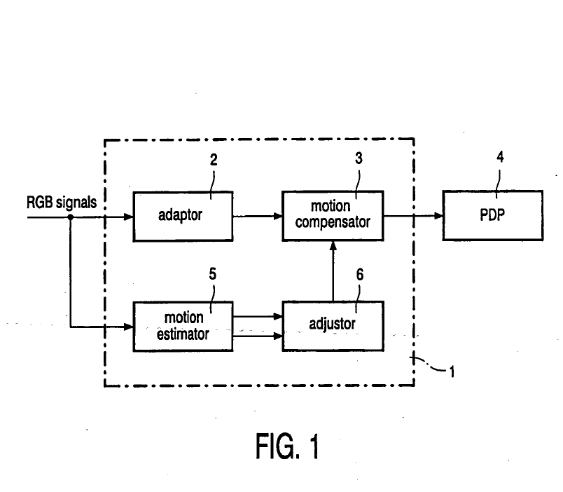

In FIG. 1, an example of a digital image processing device 1 is shown in which input signals (e.g. RGB signals) are input for an adaptor 2, and the same input signals are input for a motion estimator 5. The adaptor 2 produces images which are input for a motion compensator 3. The motion compensator 3 is connected to a PDP display 4. The motion estimator 5 produces motion vectors, which are input for an adjustor 6 for adjusting the motion vectors. The motion estimator 5 estimates motion vectors for predetermined blocks of pixels according to state of the art algorithms.

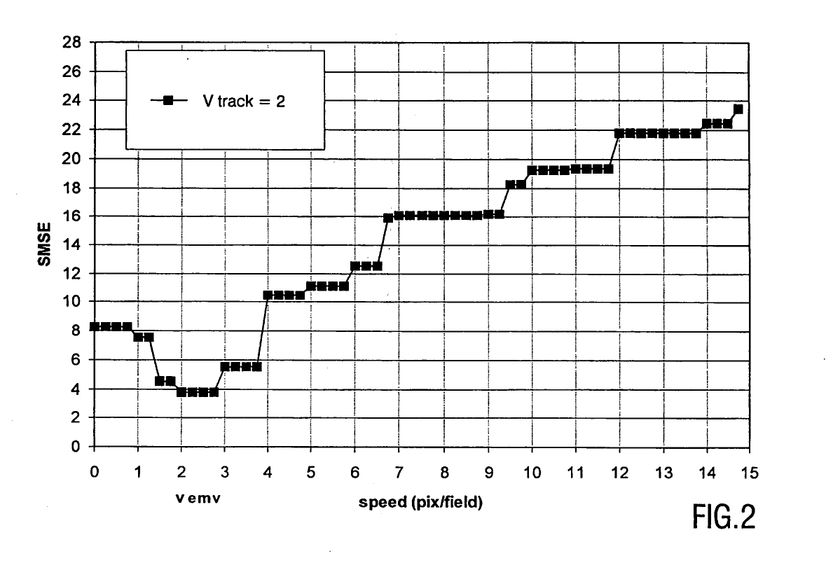

The invention will first be explained with reference to FIG. 2 that shows a “Subjective Mean Square Error” (SMSE) value as a function of a motion vector speed vₑₘᵥ (in pixels/field) as estimated by the motion estimator 5 and as used by the motion adjustor 6 to perform motion compensation, with the tracking speed v_{track} of the human eye as a parameter. The tracking speed v_{track} of the human eye is defined as the speed of the focus of the human eye on the PDP display 4, the human eye trying to track a moving object on the PDP display 4. Using SMSE values is known to persons skilled in the art. Reference is for instance made to H. Marmolin, Subjective MSE measures, IEEE Trans. On Systems, Man and Cybernetics, Vol. 16, No. 3, blz. 486, 1986 and H. Blume, H. Schroder, Image format conversion-algorithms, architectures applications, Proceedings of the ProRISC/IEEE Workshop on Circuits, Systems and Signal Processing, blz. 19, 1996.

In FIG. 2, v_{track} is assumed to be equal to 2 pixels per frame. One can easily see that when the estimated motion vector speed vₑₘᵥ is equal to 2 pixels per field the SMSE has the smallest value. This can be easily understood: when the estimated motion vector speed vₑₘᵥ equals the tracking speed v_{track} the actual speed of the block of pixels tracked by the human eye has also that speed (when the eye is tracking correctly) and the motion compensation is performed as accurate as possible.

However, when the motion estimator 5 has generated a larger or lower estimated motion vector speed vₑₘᵥ the SMSE value increases since the estimated motion vector speed vₑₘᵥ is wrong and the motion compensation as performed by adjustor 6 is based on a wrong motion vector speed The larger the difference between the tracking speed v_{track} and the estimated motion vector speed vₑₘᵥ, the larger is the SMSE. FIG. 1 shows step wise jumps of SMSE due to the use of subfields in a field.

A further observation of FIG. 2 is as follows.

When v_{track}=2 pixels/frame and vₑₘᵥ=2 pixels/field, SMSE=4.0. However, when vₑₘᵥ increases to about 2.75 pixels/field SMSE does not substantially increase and remains 4.0. Thus, when an estimated motion vector speed vₑₘᵥ would be multiplied by a factor R of 0.7-0.8 to render a reduced estimated motion vector R.vₑₘᵥ, when the estimated motion vector vₑₘᵥ is 2.75 pixels/field whereas the real motion vector speed should be 2.0 pixels/field (assumed to be equal to v_{track}), and this reduced estimated motion vector R. vₑₘᵥ would be used by the motion compensator 3 to perform motion compensation, SMSE would not change.

Moreover, starting with a correct estimated motion vector speed vₑₘᵥ=2.0 pixels/field and then multiplying by R=0.7-0.8, would render an increase in SMSE. However, the increase is no more than about 10% and still very acceptable. Therefore, in accordance with the main idea of the invention, the estimated motion vector speed vₑₘᵥ is reduced by a factor R, where 0<R<1. This can be implemented by the adjustor 6 in FIG. 1. This results in a same or better perceived quality when the estimated motion vector speed vₑₘᵥ is too high and an acceptable perceived quality when the estimated motion vector speed vₑₘᵥ is correct.

It is observed that for other values of v_{track} than 2 pixels/frame (and, thus, for other motion vector speeds of blocks tracked by the human eye) similar figures as FIG. 2 will result. However, the best value of R derived from such figures may differ from 0.7-0.8. However, for most practical situations R=0.7-0.8 has been shown to be a preferred value. Thus, adjustor 6 could be implemented as a software or hardware multiplier multiplying the motion vectors received from motion estimator 5 by R.

However, in a more sophisticated embodiment, a quality factor F(q) depending on an estimated quality factor F(q) depending on an estimated quality level q for each motion vector can be taken into account. Then, for each motion vector, the motion estimator estimates a quality level. This can be done using any (known) technique to estimate a quality level for a motion vector. When using block matching, this can be done by examining the difference between a current block of pixels in a current image and a block of pixels in the last image before the current image that looks most similar to the current block of pixels. Blocks of pixels having the best match relate most probably to the same block. One can use, e.g., a “sum of absolute difference” (called “SAD”) as an error value for the match. SAD is known as such and can be calculated fast. The smaller the value of SAD, the more reliable is the motion estimation. The quality level q of the motion estimation may be derived from such an SAD. However, alternatively, quality level q may be calculated for objects within an image or for an entire image. Moreover, quality level q may depend on the number of subfields used per subfield or the values of the subfields. E.g., certain subfield values result in lower quality levels q than others depending on the number of bit changes to be made when the value changes only slightly. In a preferred embodiment, the quality levels q are sent to the adjustor 6. In the adjustor 6, the motion vectors are adjusted by way of multiplying them by the reduction factor R and by the quality factor F(q). The quality F(q) is a function that increases with the quality level of a motion vector. The function is limited between zero and one. So, if the quality of an estimated motion vector in poor, the factor F(q) will be low, and if the quality of an estimated motion vector is perfect, the factor F(q) will be approximately equal to one. Investigations have shown that R.F(q)=0.3 may be a preferred lower limit for R.F(q) when q is very low.

It will be evident to persons skilled in the art that, instead of multiplying each motion vector with R.F(q), where q depends on the motion vector concerned, each motion vector may be multiplied by one function taking both R and q into account. It will be understood that the arrangement of FIG. 1 is just one example of implementing the invention. The motion estimator 5 and the adjustor 6 can, e.g., be implemented separately as shown, however, they may also be combined in a single unit performing both functions, that functionality being implemented in hardware or software, or partly in hardware and partly in software.

Moreover, all of the boxes shown in digital image processing device 1 may be implemented as one computer with a memory storing proper instructions and data to perform the desired functions. As persons skilled in the art know, such a memory may comprise one or more of the following units: RAM, ROM, EEPROM, hard disc, etc.

Thus, where in the claims reference is made to units as shown in FIG. 1, it is intended as a reference to the required functionality only and not as a limitation as to possible embodiments.

It is observed that the invention can advantageously in all kinds of digital image systems where a subfield driven method is combined with a motion compensation technique, and is, therefore, not restricted to the field of PDPs.

Furthermore it is observed that the invention can be applied in other kinds of systems, where the motion compensation is executed for other reasons. For example, the invention may be used for scan rate conversion where interpolated images have to be calculated between the input images in order to increase the frame rate.

1. A image processing device arranged to perform a motion compensation technique on received input signals, comprising an adaptor for adapting said input signals to create images, a motion compensator for compensating the images for motion, a motion estimator for estimating motion vectors using the input signals, said motion vectors being used by said motion compensator, characterized in that said image processing device further comprises an adjustor for adjusting said motion vectors before feeding them to said motion compensator, said adjustor being arranged to multiply said motion vectors by a reduction factor, said reduction factor being a positive value less than one.

2. The image processing device according to claim 1, wherein said reduction factor has a fixed value of between 0.7 and 0.8.

3. An image processing device according to claim 1, characterized in that said motion estimator is arranged to determine a quality level q, said quality level q being input for a progressive quality function F(q), which is limited between zero and one, said adjustor being arranged to multiply said motion vectors also by said quality function F(q) before feeding them to said motion compensator.

4. The image processing device according to claim 3, wherein said motion estimator determines said quality level q either for all motion vectors separately, for each object in said image separately or for said image as a whole.

5. The image device according to claim 3, wherein said reduction factor multiplied by said quality function F(q) has a lower limit of 0.3.

6. A display arrangement comprising an image processing device according to claim 1 and a display for receiving output signals from said motion compensator.

7. A method for driving an image processing device comprising:
receiving input signals;
adapting said input signals to produce consecutive images;
adjusting said consecutive images using motion compensation;
estimating motion vectors out of said input signals;
using said motion vectors in said motion compensation,
characterized by adjusting said motion vectors before using them in said motion compensation by multiplying said motion vectors by a reduction factor, said reduction factor being a positive value less than one.

8. A method according to claim 7, characterized in that said reduction factor has a fixed value between 0.7 and 0.8.

9. A method according to claim 7, characterized by:
determining a quality level q during said step of estimating motion vectors;
input said quality level q to a progressive quality function F(q), which is limited between zero and one;
multiplying said motion vectors also by said quality function F(q), before using them in said motion compensation.

10. A computer program product to be loaded by an image processing device, said computer program product providing said device with the capacity of:
receiving input signals;
adapting said input signals to produce consecutive images;
adjusting said consecutive images using motion compensation;
estimating motion vectors out of said input signals;
using said adjusted motion vectors in said motion compensation,
characterized by adjusting said motion vectors before using them in said motion compensation by multiplying said motion vectors by a reduction factor, said reduction factor being a positive value less than one.

11. A computer program product according to claim 10, characterized in that said computer program product further provides said device with the capacity of:
determining a quality level q during said step of estimating motion vectors;
input said quality level q to a progressive quality function F(q), which is limited between zero and one;
multiplying said motion vectors also by said quality function F(q), before using them in said motion compensation.

12. A data carrier provided with a computer program product according to claim 10.
